(19) United States
(12) Patent Application Publication
(10) Pub. No.: US 2013/0075371 A1
(43) Pub. Date: Mar. 28, 2013

(54) NON-DESTRUCTIVE EVALUATION OF WELDED JOINTS OF BAR WOUND STATOR UTILIZING INFRARED AND THERMAL METHODS

(71) Applicants: Urban J. De Souza, Rochester Hills, MI (US); Edward Panozzo, Mokena, IL (US); Daniel L. Simon, Rochester, MI (US); John S. Agapiou, Rochester Hills, MI (US); Xiaoling Jin, Farmington Hills, MI (US)

(72) Inventors: Urban J. De Souza, Rochester Hills, MI (US); Edward Panozzo, Mokena, IL (US); Daniel L. Simon, Rochester, MI (US); John S. Agapiou, Rochester Hills, MI (US); Xiaoling Jin, Farmington Hills, MI (US)

(73) Assignee: GM GLOBAL TECHNOLOGY OPERATIONS LLC, Detroit, MI (US)

(21) Appl. No.: 13/240,449

(22) Filed: Sep. 22, 2011

(51) Int. Cl. B23K 11/24

(52) U.S. Cl. 219/109

(57) ABSTRACT

A method and system for non-destructive evaluation of one or more welds of a stator includes activating the stator welds using an electrical current; recording radiometric thermal images of the welds over time; and analyzing a temperature-time profile of a weld to qualify the weld by one or more of estimating the size of the weld, determining if the temperature of the activated weld has exceeded a predetermined temperature at a predetermined time, or comparing the temperature-time profile of the weld to a reference. The stator may be configured as a bar wound stator. A mask may be applied to the stator to reduce reflections or emissions from non-weld thermal sources.

### TECHNICAL FIELD

The present invention relates to a method and system for evaluating welds in electric devices using radiometric-infrared thermography.

### BACKGROUND

Electric devices such as motors and generators having a stator secured within a housing of the motor/generator are well known. A rotor mounted on a shaft is coaxially positioned within the stator and is rotatable relative to the stator about the longitudinal axis of the shaft to transmit the force of the motor. The passage of current through the stator winding creates a magnetic field causing the rotor and shaft to rotate.

Some stators are generally configured as an annular ring and are formed by stacking thin plates, or laminations, of magnetic steel. A copper winding of a specific pattern is configured, typically in slots of the lamination stack, through which current flows to magnetize the stator assembly and to create a force that causes the rotation of the rotor.

Bar wound stators are a particular type of stator that include a winding including a plurality of shaped magnet wires, which may also be referred to as preformed wires, formed wires, wire forms, hair pins, bar pins, formed bars, or bar wires. The bar may be formed from a heavy gauge copper wire with a rectangular cross section and generally configured in a formed shape having a curved section at one end and typically terminating in two wire ends at the opposite end. The bars are accurately formed into a predetermined shape for insertion into generally rectangular slots in the bar wound stator, in a predetermined pattern.

Typically, the curved ends of the bars protrude from one end of the lamination stack and the wire ends of the bars protrude from the opposite end of the lamination stack. After insertion, the straight portions of the wire protruding from the lamination stack are bent to form a complex weave from wire to wire, creating a plurality of wire end pairs. Adjacent paired wire ends are typically joined to form an electrical connection by welding one wire end to its adjacent or paired wire end to form a welded joint, where each pair of wires is individually welded, for example, by arc welding. The resultant weave pattern and plurality of welded joints determines the flow of current through the motor.

Electrical conductivity and structural integrity of the welded joint between each of the paired wire ends are key factors determining motor quality and performance. Joint quality can be affected by the weldability of the wire, the geometry of the wire ends, the cleanliness of the wire surfaces prior to welding, defects such as porosity and microcracks introduced into the weld, spatter produced in the arc welding process, the cross-sectional or surface area of the weld and other factors. Joint quality can also be affected by variation in the positioning of the adjacent wire ends as a result of the bending process, where spacing and proximity of the wire ends to each other may contribute to variability in the welded joint. Variability in the process and configuration of each wire end pair may result in variability in the electrical connection of each wire end pair. When the motor is placed into operation, this may result in thermal variation in the operation of the motor, localized overloading of the welded joint causing an electrical discontinuity, e.g., an open circuit, in the winding due to, for example, welds of minimal surface or cross-sectional area or with a small heat-affected zone. Failure of the motor in operation may result in customer dissatisfaction, downtime and/or loss of productivity, and/or repair or warranty costs.

Destructive test methods, such as metallographic evaluation and/or mechanical testing, may be used to evaluate weld quality. Visual examination of the welded joints provides a non-destructive approach to weld quality assessment, however may not be fully effective in detecting a weld of minimal surface or cross-sectional area, nor does visual examination provide an evaluation of the effective size of the heat-affected zone. Functional end of line testing of a motor assembly including the bar wound stator provides a general assessment of the electrical performance of the motor and its winding, however may not be sufficient to identify a specific weld within the stator as a causal factor of poor electrical performance. Further, evaluation of the stator welds after end of line testing of the motor requires disassembly of the motor for inspection of the stator welds, incurring costs associated with disassembly, testing, rework, reassembly and retest of the stator and motor.

### SUMMARY

A method and system for non-destructive evaluation of an array of welded joints including a plurality of welds are provided herein. The evaluation method and system is generally based on the accurate mapping of temperature rise in the plurality of welds when electrical current is conducted through the array of welded joints, where the mapping is conducted using thermal imaging technology. In a non-limiting example, the array of welded joints may be defined by the welded wire end pairs of the wire end portion of a stator assembly. The stator assembly may be configured as a bar wound stator including a plurality of bar pins, each bar pin including one or more wire ends forming a plurality of wire end pairs. Each wire end pair may be joined by welding to form a plurality of welded joints. The system may include an electrical current source configured to be selectively connected to the plurality of welds and providing a predetermined level of current to activate or energize the plurality of welds, an infrared (IR) camera configured to capture at least one thermographic image of the activated plurality of welds, and a processor configured to analyze said at least one thermographic image to qualify at least one weld of the plurality of welds. The infrared camera may be configured to capture a plurality of thermographic images of the activated plurality of welds over time. The processor may be further configured to estimate the size of the at least one weld, to determine if the temperature of the at least one weld has exceeded a predetermined temperature at a predetermined time, and/or to develop a temperature-time profile at a predetermined level of current of at least one weld of the plurality of welds using the plurality of thermographic images and to qualify the at least one weld by comparing the temperature-time profile of the at least one weld to at least one reference temperature-time profile.

In a non-limiting example, a masking device may be used to isolate the plurality of welds such that at least one of reflections and emissions of radiant energy from sources other than the plurality of welds is substantially reduced. The masking device may include a plurality of masking elements which may be selectively positioned relative to each other. In another non-limiting example, an orienting mechanism to orient the stator with respect to the infrared camera may be included, such that the location of said at least one weld on the stator is identifiable.

A method for non-destructive evaluation of an array of welded joints of a bar wound stator, the array of welded joints including a plurality of welds, is provided. In a non-limiting example, the method may include orienting the bar wound stator with respect to an infrared camera, such that the location of each weld of the plurality of welds is identifiable during analysis of a thermal image of the array produced by the infrared camera.

The method may include activating the array of welded joints using an electrical current provided to the bar wound stator, recording a plurality of thermal images of the activated array over time, analyzing the plurality of thermal images to develop a temperature-time profile of each weld of the plurality of welds, and evaluating the temperature-time profile of each weld of the plurality of welds to qualify each weld of the plurality of welds. Qualifying each of the plurality of welds may include estimating the size of each weld, determining if the temperature of each weld has exceeded a predetermined temperature at a predetermined time, or comparing the temperature-time profile of each of the welds to at least one reference. In a non-limiting example, the method may further include coating each of the plurality of welds to substantially standardize the emissivity of each of the plurality of welds when activated, and/or masking the array of welded joints to substantially reduce at least one of reflections and emissions of radiant energy from sources other than the plurality of welds, and/or to enhance the sensitivity of the method to determine weld quality.

The above features and other features and advantages of the present invention are readily apparent from the following detailed description of the best modes for carrying out the invention when taken in connection with the accompanying drawings.

### BRIEF DESCRIPTION OF THE DRAWINGS

FIG. 1A is a schematic plan view of the welded wire end portion of a bar wound stator assembly positioned for evaluation;

FIG. 1B is a partial schematic view of the welded wire end portion of the bar wound stator assembly of FIG. 1A;

FIG. 2 is a schematic illustration of a thermogram of the welded wire end portion of the bar wound stator assembly of FIG. 1A in an activated state;

FIG. 3 is a graphical illustration of temperature over time readings of a plurality of measurement locations on the thermogram of FIG. 2 corresponding to a plurality of welded joints having welds of varying nugget size;

FIG. 4 is a schematic illustration of welds of varying nugget size forming the welded joints represented in FIG. 3;

FIG. 5A is a graphical illustration of temperature over time readings of a plurality of measurement locations on the thermogram of FIG. 2 corresponding to a plurality of welded joints;

FIG. 5B is portion of FIG. 5A enlarged for magnification purposes;

FIG. 6A is a schematic illustration of the welded wire end portion of the bar wound stator of FIG. 1A including a masking device;

FIG. 6B is a partial schematic illustration of an alternative configuration of the masking device of FIG. 6A in a first position;

FIG. 6C is a partial schematic illustration of the masking device of FIG. 6B in a second position;

FIG. 6D is a partial schematic illustration of an alternative configuration of a masking element of the masking device of FIG. 6B;

FIG. 7 is a flow chart of a method for evaluating the welded joints of the bar wound stator of FIG. 1A; and

FIG. 8 is a system for evaluating the welded joints of the bar wound stator of FIG. 1A.

### DETAILED DESCRIPTION

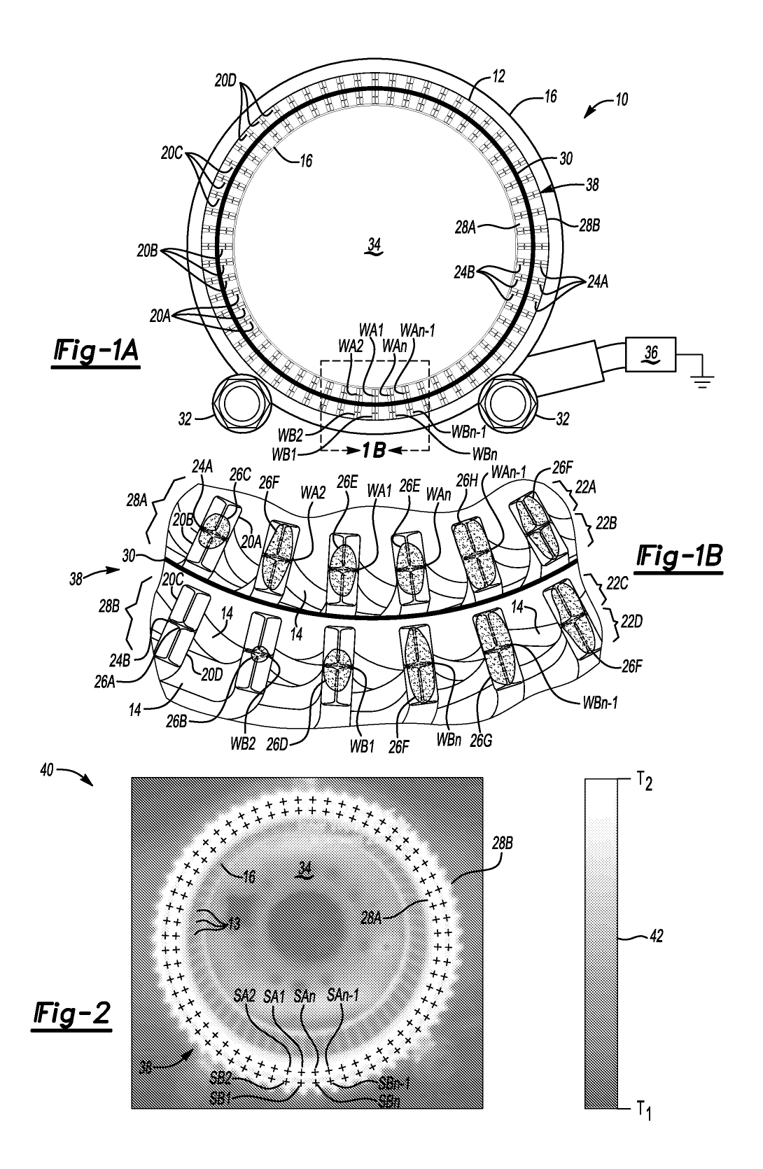

Referring to the drawings wherein like reference numbers represent like components throughout the several figures, the elements shown in FIGS. 1-8 are not to scale or proportion. Accordingly, the particular dimensions and applications provided in the drawings presented herein are not to be considered limiting. A method and system for non-destructive evaluation of the welds of a stator are provided herein. The stator assembly may be configured as a bar wound stator including a plurality of bar pins, each bar pin including one or more wire ends positioned relative to another wire end to form a plurality of wire end pairs. Each wire end pair may be joined by a weld forming a welded joint between the wire ends of each wire end pair. One or more of the plurality of welds joining the respective wire end pairs of the bar wound stator may be evaluated and qualified using the non-destructive method and system described herein.

The method and system of non-destructive evaluation of the welds joining the wire end pairs provides the advantage of defining an optimum weld size, detecting welds of minimal surface or cross-sectional area, welds containing porosity or microcracks, welds containing inclusions such as metallic oxides or dirt, and/or welds having a small heat-affected zone with better accuracy and repeatability than, for example, visual inspection of the stator and/or functional end-of-line testing of the fully assembled motor. By detecting and repairing, reworking or removing these stators from production and prior to assembly into a motor, total motor manufacturing cost and/or motor warranty costs may be reduced.

FIGS. 1A and 1B shows the wire end portion 12 of a bar wound stator assembly 10, also referred to herein as a stator. The stator 10 may be generally configured as an annular ring and includes a lamination stack 16, which may be formed by stacking laminations in a specific pattern. Each lamination may include a plurality of radially distributed slots which may be oriented during assembly of the lamination stack 16 to define a plurality of generally rectangular slots 13 (see FIG. 2) which are distributed radially and extend from end to end of the stack 16.

The stator 10 is shown in FIGS. 1A and 1B configured as a bar wound stator, such that a winding may be formed from a plurality of bar pins 14, also referred to as bar pin wires. The bar pins 14 are typically formed from a heavy gauge, high conductivity copper wire with a rectangular cross section and each bar pin 14 is generally configured in a hairpin shape having a curved section (not shown) and typically terminating in two wire ends 20. The bar pins 14 are accurately formed into a predetermined shape for insertion into the slots 13 (see FIG. 2) of the lamination stack 16 in a predetermined weave pattern.

FIGS. 1A and 1B shows the wire ends 20A-20D of the bar pins 14 protruding from one end of the lamination stack 16. The wire ends 20A-20D may be collectively referred to herein as the wire ends 20. After insertion, the wire ends protruding from the lamination stack 16 are bent to form a complex weave from wire to wire, wherein the plurality of bent wire ends 20 is generally referred to as the wire end portion 12 of the stator 10. The collective wire ends 20 of bar pins 14 have been arranged in four layers identified as 22A-22D (see FIG. 1B) in the lamination stack 16, where the first or innermost layer 22A includes a plurality of wire ends 20A closest to the inner diameter of the lamination stack 16, and the fourth or outermost layer 22D includes a plurality of wire ends 20D closest to the outer diameter of the lamination stack 16. The second layer 22B, which is proximate to the first layer 22A, is formed of a plurality of wire ends identified as wire ends 20B. The third layer 22C, which is proximate to a fourth or outermost layer 22D, is formed of a plurality of wire ends identified as wire ends 20C.

FIGS. 1A and 1B show each of the wire ends 20A in the first layer 22A is bent such that it is proximate to and paired with a wire end 20B in the second layer 22B, to form a wire end pair 24A. The wire ends 20A and 20B are welded together, for example, by an arc welding method such as gas tungsten arc welding (GTAW), plasma arc welding (PAW), or another suitable welding method for welding the wire ends 20A and 20B, to form a weld 26, thus forming a welded joint generally identified as WA. As used herein, a weld or welds 26 refers collectively to the weld forming the plurality of welded joints WA, WB, which may be of varying shape, cross-section and/or size as shown for welds 26A-26G. The welded joints WA collectively form a first or inner layer 28A of welded joints WA formed by a weld 26 and wire end pair 24A. Each of the welded joints WA may be individually identifiable by its respective location in the inner layer 28A of an array generally identified at 38. In a non-limiting example and referring to FIG. 1A, the stator 10 may be oriented in a repeatable manner such that the welded joint immediate to the left of the bottom, or six o'clock position in the inner layer of the array 38 (as seen on the page) is designated as a first welded joint WA1 when the stator 10 is in the oriented position. The welded joint located immediately clockwise and adjacent to the first welded joint WA1 may be identified as a second welded joint WA2 in the inner layer 28A, and so on, continuing in a clockwise manner such that each of the n welded joints of the inner layer 28A are identified. As shown in FIGS. 1A and 1B, the nth welded joint WAn of the inner layer 28A is located immediately counterclockwise to the first welded joint WA1, and between the welded joints WA1 and WAn−1.

Similarly, each of the wire ends 20C in the third layer 22C is bent such that it is proximate to and paired with a wire end 20D in the fourth layer 22D, to form a wire end pair 24B. The wire ends 20C and 20D are welded together, for example, by arc welding or another welding method as described previously, to form a weld 26, thus forming a welded joint generally identified as WB. The welded joints WB collectively form a second or outer layer 28B of welded joints WB formed by a weld 26 and wire end pair 24B. Each of the welded joints WB may be individually identifiable by its respective location in the outer layer 28B of the array 38. In a non-limiting example and referring to FIG. 1A, the stator 10 may be oriented in a repeatable manner such that the welded joint immediate to the left of the bottom, or six o'clock position on the outer layer 28B of the array 38 (as seen on the page) is designated as a first welded joint WB1 when the stator 10 is in the oriented position. The welded joint located immediately clockwise and adjacent to the first welded joint WB1 may be identified as a second welded joint WB2 in the outer layer 28B, and so on, continuing in a clockwise manner such that each of the n welded joints of the outer layer 28B are identified. As shown in FIGS. 1A and 1B, the nth welded joint WBn of the outer layer 28B is located immediately counterclockwise to the outer welded joint WB1, and between the welded joints WB1 and WBn−1.

The stator 10 may be oriented in a repeatable manner for non-destructive evaluation by locating the stator 10 in the fixture 32 shown in FIG. 1 (also see FIG. 8) by matching a feature of the stator 10 to a feature of the fixture 32. In a non-limiting example, the stator 10 may be oriented by connecting or inserting the terminals of stator 10 (not shown) to an outlet (e.g., a terminal connector) of an activation source which is oriented with respect to the fixture 32, which may be, for example, a current source 36 which is selectively connected to stator 10 to activate the welds 26 during non-destructive evaluation, as described in further detail herein. The position of the first welded joint WA1, WB1 in each respective layer 28A, 28B of the array 38 may then be identified with respect to the orientation of the stator 10 in the fixture 32. In another non-limiting example, the position of the first welded joint WA1, WB1 in each respective layer 28A, 28B may be identified with respect to a feature of the stator 10, for example, with respect to a terminal end (not shown) or another characteristic of the lamination stack 16, the wire end portion 12, or other identifying mark or characteristic which may be correlated to a thermographic reading as described in further detail herein. A masking device, as described herein, and/or an orienting mechanism (not shown) may be configured to include a heated or cooled indicator (not shown) oriented relative to a feature of the stator 10, the lamination pack 16, the wire end portion 12, or the array 38 to provide an identifying mark or indicator which may be used to correlate a thermographic reading of the array 38 to the plurality of welds 26 included therein.

Referring to FIG. 1B, a plurality of welds 26 joining a plurality of wire end pairs 24A, 24B to form a plurality of welded joints WX are shown in additional detail. As used herein, WX refers to the plurality of welded joints including the plurality of welded joints WA and the plurality of welded joints WB which are arranged as shown in a pattern or array 38. An individual welded joint may be referred to as WXx, which may be one of the welded joints WA1 . . . WAn or WB1 . . . WBn.

Electrical current may be conducted through the stator winding via the weave pattern established by the bar pins 14 and the plurality of welded joints WX. The electrical current passes through the fused area of each of the welds 26, which can be of variable size, as shown by the non-limiting example welds 26A, 26B, 26C, 26D, 26E, 26F, 26G, 26H in FIGS. 1B and 4. The size of each weld 26 may vary due to variability of the welding process, variation in the configuration and/or shape of the wire ends 20 forming the wire end pair 24, variation in the location of each wire end 20 in the weave pattern, or other causes of weld parameter variation such as argon gas flow rate, electrode wear or breakage, etc. The size and cross-sectional area of a weld 26, and welding defects such as porosity, microcracks, and contamination, may affect the current carrying capacity of the welded joint formed by the weld 26. Weld defects can lead to increased electrical resistance within the weld itself as electrical current flowing through a zone of higher resistance will generate heat. The formula V=I·R shows the relationship between current flow (I) and resistance (R), resulting in a voltage drop (V) across the zone (the welded joints) of increased resistance. This voltage drop when entered into the formula P=I·V shows that electrical power (P) is generated as a function of the increased voltage drop (V) times the current (I) flowing through the weld. For a fixed current, as resistance increases, as would be observed for an insufficient or defective welded joint having a smaller weld section for current to flow through, the voltage increases and the energy or power increases, generating increased temperature at the welded joint. This power manifests itself as heat, which is detected by thermal images of the welds generated while under test.

A missing or severely undersized weld (26A, for example) may cause an “open,” e.g., may result in an open electrical circuit within the stator winding due to excess heat. A smaller sized or poorly formed weld (26B, 26C, for example) may be susceptible to overloading during current loading, causing a hot spot, weld failure and/or opening of the electrical circuit within the stator winding. Accordingly, it is an advantage to detect welds characterized by such conditions using a repeatable and accurate method of non-destructive evaluation, as described herein, such that a stator 10 including an unacceptable weld 26 may be contained for repair or reworked of the insufficient weld, or scrapped, in either case preventing the assembly of the stator 10 with the insufficient weld into a motor assembly.

Further, by including a method of identifying each weld (WA1, WA2 . . . WAn, WB1, WB2 . . . WBn) during evaluation, by orientation of the stator 10 to the test fixture 32 or otherwise, rework or repair of the suspect or insufficient welds (for example, welds 26A, 26B, 26C as shown in FIGS. 1B and 4) can be efficiently performed. In a non-limiting example, for some applications where higher current loads to the stator 10 may be anticipated, it may be desirable to ensure a minimum level of weld size to further decrease the potential for electrically overloading the welds within the stator winding by identifying welds of less than a predetermined size, for example, welds smaller than weld 26E, referring to FIGS. 1B and 4, which may be marginally qualified for the extended operation at the higher current loads. In another non-limiting example, for some applications where surge loads may be anticipated, the energizing current may be increased to a higher amperage, for example, the current may approximate 500 A during the test cycle.

FIG. 2 shows a non-limiting example of a thermographic image 40, which may also be referred to herein as a radiometric thermal image, a thermal image, or a thermogram, of an activated array 38 including a plurality of welded joints WX formed by a plurality of welds 26. The thermogram 40, which would be understood to typically be a color image, is reproduced in FIG. 2 in grayscale (or black and white). The color image is used for human interpretation of the thermal response of the welds to current flow. For computer interpretation, grayscale data is typically captured with pixel values from 0-255 representing the temperatures measured by radiometric thermal imaging. A temperature scale or reference 42, is also reproduced as FIG. 2 in grayscale (e.g., black and white). The temperature scale 42 would be understood to typically be a color image corresponding to the thermogram 40 and used as a reference to interpret the areas of various temperature shown on the colored thermogram 40. The thermogram 40 may be captured and generated using, for example, an infrared (IR) or thermographic camera, which may be, for example, the IR camera 160 shown in FIG. 8. It would be understood that the color images of the thermogram 40 and corresponding temperature scale 42 as generated by the IR camera 160 would show the warmest areas of the image (e.g., the portions of the array 38 approaching T₂ in temperature) customarily colored white (generally corresponding to a pixel value 255), areas of the image of an intermediate temperature (e.g., between T₁ and T₂) customarily colored red to yellow, where an area colored red would be warmer than an area colored yellow, and the coolest areas of the image (e.g., the portions of the array 38 approaching T₁ in temperature) customarily colored blue.

A method of non-destructive evaluation of one or more of the welds 26 included in the array 38 of the stator 10 shown in FIG. 2 may include activating, e.g., energizing, the weld array 38, for example, by introducing a current to the electrical circuit of the stator 10 including the welds 26 using a current source 36 (see FIGS. 1 and 8) selectively connected to the stator 10, and generating a series of radiometric thermal images 40 at various time intervals beginning at time t=0 with the introduction of the current to the stator 10, and continuing through a predetermined interval of time, which may be, for example, a test time interval tₜₑₛₜ. Each of the activated welds 26 of the welded joints WX included in the array 38 may increase in temperature from time t=0 through tₜₑₛₜ, such that the change in temperature over time of each of the activated welds 26 can be determined from a series of thermal images 40 taken and recorded at time intervals beginning at time t=0. In a non-limiting example, the time tₜₑₛₜ is a predetermined time between 10 seconds and 60 seconds. In another non-limiting example, the time tₜₑₛₜ is approximately 30 seconds. The IR camera 160 may record and transmit the series of thermal images 40 to a processor such as the processor 165 shown in FIG. 8 for further analysis including the non-destructive evaluation of one or more of the welds 26 included in the array 38. The IR camera 160 may be an infrared camera, a radiometric IR camera, a thermographic camera, or similar. In a non-limiting example the IR camera 160 is preferably configured as a high resolution IR camera. A high resolution IR camera would utilize a focal plane detector of size 640 by 480 pixels. By distinction, a minimal resolution IR camera may be defined as having an active focal plane array IR radiation detector of size 340 by 240 pixels.

The processor 165 of FIG. 8 may be configured, in a non-limiting example, to include a memory, a central processing unit (CPU) and one or more algorithms which may be executed by the CPU to analyze the thermograms 40 generated by the IR camera 160. The memory can include, by way of example, Read Only Memory (ROM), Random Access Memory (RAM), electrically-erasable programmable read only memory (EEPROM), etc., of a size and speed sufficient for receiving, analyzing and storing the thermograms 40, for estimating the weld size or configuration of the welds 26 using one or more algorithms, to generate and/or store reports or other data related to or required by the method of non-destructive weld evaluation described herein. The processor 165 may be configured to display inspection results, generate reports, and receive other inputs or output data to other devices. The IR camera 160 and the processor 165 may be operably connected using wired or wireless means, for example, the IR camera 160 and the processor may be adapted for communication with each other through a contact or contactless means, which may include communication through any suitable wireless connection such as RFID, Bluetooth™ or other near field communication means, or through a USB port or other suitable means of contact. In a non-limiting example, the processor 165 may be in communications with or operably connected to the current source 36 of FIG. 1 and/or the fixture 32, to receive or transmit data and/or information, such that the processor 165 may use an actual measurement of the energizing current obtained from the current source 36 as a data input when analyzing a thermogram 40 generated of an array 38 energized at the measured current level.

The array 38 shown in FIG. 2 and including the plurality of welds 26, may be activated, in a non-limiting example, by energizing the electrical circuit, e.g., the winding including the array 38, of the stator 10 using a current in the range of 100 amps (100 A) to 500 amps (500 A), provided by a current source 36 selectively connected to the stator, such that the temperature of the welded joints WX and the welds 26 increases with the duration of time energized. In a non-limiting example, the current source 36 may generate a 3-phase high-amperage, short duration electrical loading of the stator 10. The current source 36 may be provided, for example, via a traction power inverter module (TPIM), or through 3-phase delta or Y circuits powered using a phase switching AC high amperage power supply. The duration of the electrical loading may be, for example, for the time tₜₑₛₜ, although this is not intended to be limiting and electrical loading or energizing of the stator for other durations may be used. For example, the duration of electrical loading may be for a time tₜₑₛₜ plus an additional time to ensure the weld array 38 is in an energized state while a radiometric thermogram 40 is generated corresponding to time tₜₑₛₜ. In one embodiment, the stator 10 may be energized using a minimum current of 150 A. In another embodiment, the stator 10 may be energized using a current between 200 A and 300 A. Alternatively, the stator 10 may be energized using a current of approximately 280 A. In the latter case, the higher amperage loading provided by the 280 A current through the stator 10 may increase the sensitivity and/or repeatability of the weld evaluation using the IR inspection method described herein, increasing the accuracy of estimating the size and/or quality of the weld being evaluated. In another non-limiting example, the stator may be energized using a current approaching 500 A, to simulate a current surge to the stator or a worse case operating scenario, for example. The test sensitivity increases as the energizing current is increased, however higher currents may be damaging to the stator 10, for example, by deteriorating the insulation surrounding the weld 26. Therefore it may be beneficial to increase the energizing current to increase the sensitivity of the weld evaluation, while maintaining the energizing current below a level which may be detrimental or damaging to the stator 10, and/or to limit the time the weld array is under test, e.g., the length of time the weld array is energized, to prevent damage or deterioration to the stator 10 during testing. For example, the energizing current and/or test time may be limited such that the temperature of the welds 26 does not exceed a maximum temperature rating of the insulating material in the stator 10, to avoid deterioration and/or burning of the insulation.

The stator 10 may be located in a fixture 32, referring now to FIGS. 1A and 2 and the inspection system 150 shown in FIG. 8, to position wire end portion 12 and the array 38 relative to the IR camera 160 for the duration of the test cycle, the test cycle at least including energizing the array 38 and the stator 10 and recording a series of radiometric thermograms 40 at various time intervals. The fixture 32 of FIG. 8 may include a backing plate or surface 34, which may be configured to provide a positive stop for locating the stator 10 in fixture 32, or to provide a datum surface for orienting the stator 10 and/or to align the array 38 with the IR camera 160. The fixture 32 may include other features to orient the stator 10 to facilitate identification of each of the welded joints WX in the array 38. The fixture 32 may incorporate a means of selectively connecting the stator 10 to the current source 36. By way of non-limiting example, the fixture 32 may include a receptacle (not shown), which may be an electrical connector, configured to receive the terminals (not shown) of the stator winding such that the location and/or orientation of the receptacle may be used to orient the stator 10 in the fixture 32 with respect to the IR camera 160 while concurrently providing a means to electrically connect the stator 10 to the energizing or current source 36. The fixture 32 may incorporate other features not shown. For example, the fixture 32 may include a marking or labeling mechanism to mark or label the stator to identify the orientation of the stator 10 and/or array 38 with respect to one or more of the fixture 32 and the IR camera 160, and/or to facilitate identification of an individual weld 26 of a welded joint WXx in the array 38 during or after testing.

As described previously with reference to FIG. 2, a series of radiometric thermograms 40 of an array 38 may be taken at time intervals beginning at time t=0 and until at least time tₜₑₛₜ, and transmitted to a processor 165 for analysis and evaluation of one or more of the welds 26 included in the array 38. Analysis of a thermogram 40 may include the use of one or more algorithms by the processor 165 of FIG. 8. Each thermogram 40 may be captured as a digital image, which may be subdivided into sub-images, each sub-image representing a portion of the thermogram 40. Each thermogram 40 may be a digital image consisting of a plurality of pixels, for example, thermogram 40 may be configured as an image typically consisting of 640×480 pixels, which may be subdivided into sub-images where each sub-image may consist of one or more pixels, e.g., a sub-image may typically be a 3×3 pixel image or larger. The stator 10 and array 38 of welded joints WX may be oriented with respect to the IR camera 160 such that the location of each welded joint WXx including a weld 26 may be mapped to a corresponding sub-image of the thermogram 40. The individual corresponding sub-image for each weld 26 in the array 38 may be analyzed, using the processor 165, to evaluate each weld 26 and each welded joint WXx formed thereby.

Referring again to FIG. 2, shown is a plurality of signature spots including signature spots SA1, SA2 . . . SAn−1, SAn, SB1, SB2 . . . SBn−1, SBn, which may be collectively referred to as a plurality of signature spots SX. The plurality of signature spots SX are arranged as shown in a pattern or array corresponding to location of the plurality of welded joints WX. An individual signature spot may be indicated as SXx, which may be one of the signature spots SA1 . . . SAn or SB1 . . . SBn. Each individual signature spot SXx may be understood to correspond to the location on an individual welded joint WXx and a sub-image of a predetermined size. For example, the signature spot identified as SA1 in the thermogram 40 shown in FIG. 2 may correspond to the location of the welded joint WA1 shown in FIGS. 1A and 1B, the signature spot identified as SB1 in the thermogram 40 shown in FIG. 2 may correspond to the location of the welded joint WB1 shown in FIGS. 1A and 1B, and so on.

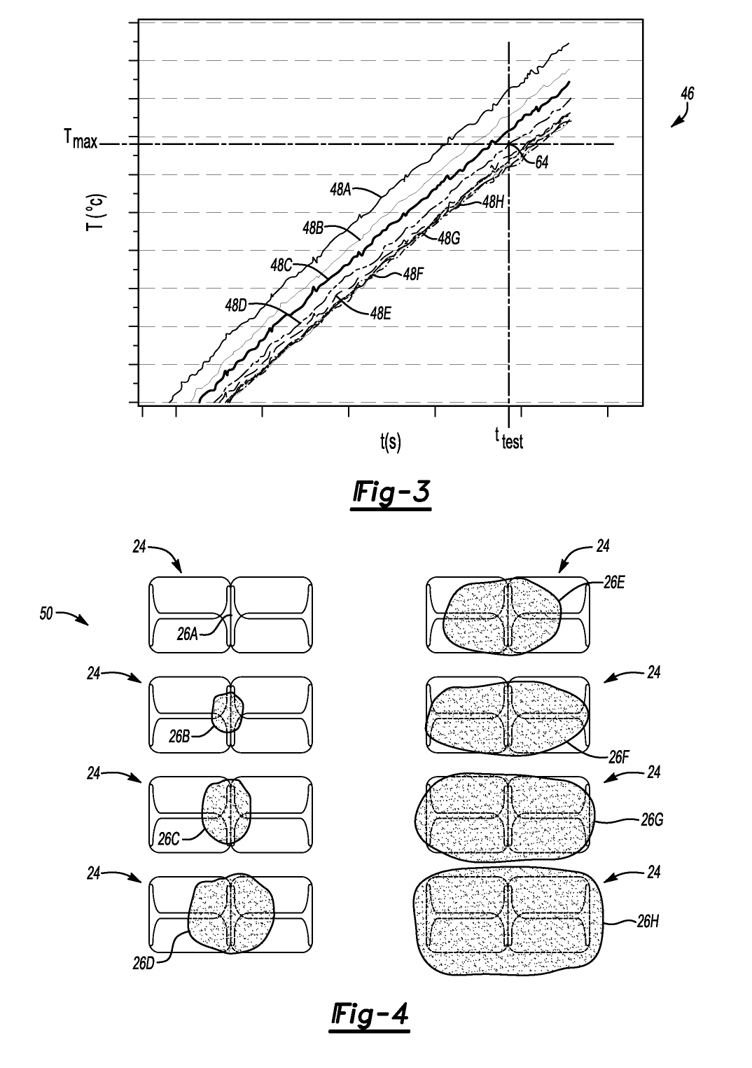

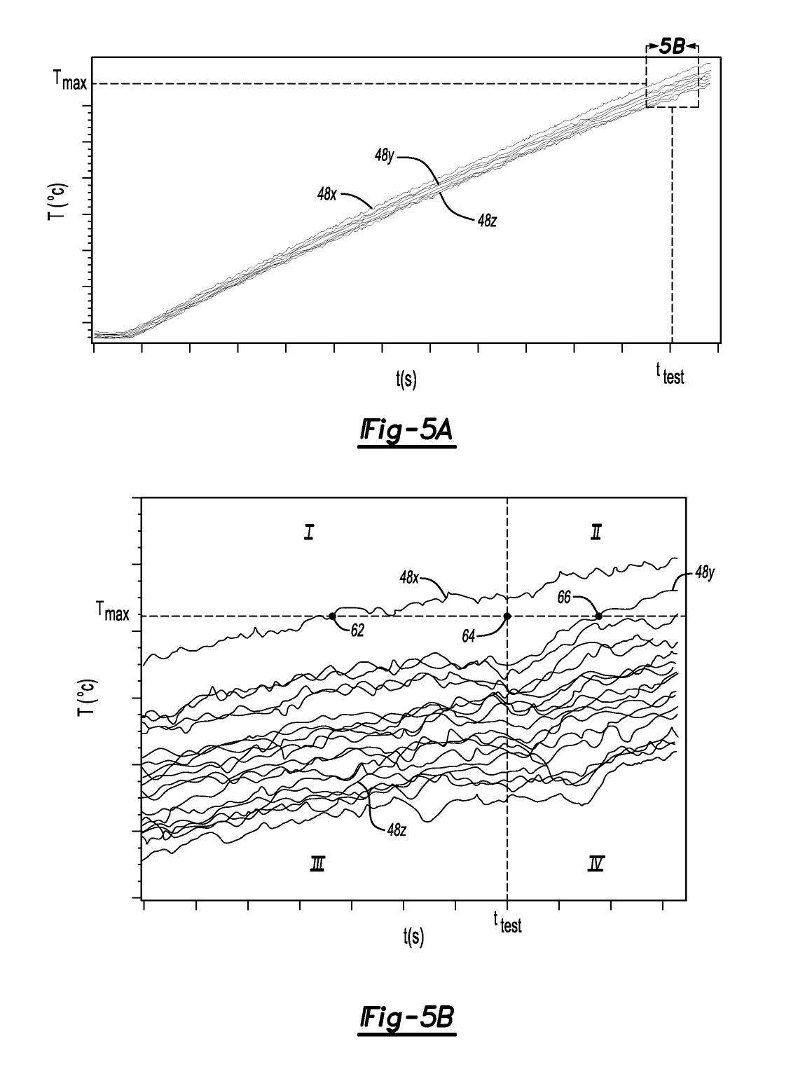

The sub-image corresponding to and recorded for an individual signature spot SXx may then be analyzed to evaluate the corresponding welded joint WXx, and the weld 26 forming the corresponding welded joint WXx. As described previously, the sub-image corresponding to an individual signature spot SXx may be analyzed by analysis of the thermogram 40 including the sub-image, using, for example, the processor 160. A series of sub-images corresponding to an individual signature spot SXx may be determined from and analyzed for a series of thermograms 40 recorded at timed intervals to evaluate the corresponding welded joint WXx. The series of sub-images may be analyzed to generate a temperature-time profile 48 (see FIGS. 3, 5A, 5B) for the signature spot SXx which may also be used to evaluate the corresponding welded joint WXx.

FIG. 3 shows a temperature-time graph 46 including a plurality of temperature-time profiles 48A-H. Each temperature-time profile corresponds to a signature spot SXx and welded joint WXx including a weld 26A-H, and represents the measured temperature of the signature spot SXx at various times during the energizing cycle, beginning at t=0 and through the end of the test or energizing cycle, which may be, for example, time tₜₑₛₜ or a predetermined time after tₜₑₛₜ. The temperature-time profile 48 can then be used to evaluate the actual temperature of the signature spot SXx at any point in time during the energizing or test cycle, and may also be used to evaluate the rate of temperature increase during the energizing or test cycle represented by the slope of the temperature-time profile 48. By way of non-limiting example, each temperature-time profile 48A-H shown in graph 46 of FIG. 3 represents the thermal output measured from a corresponding weld 26A-H shown in FIG. 4, e.g., the temperature-time profile 48A corresponds to the weld 26A, the profile 48B corresponds to the weld 26B, and so on.

As described previously, the stator 10 may be oriented in the fixture 32, or by other means, to orient the array 38 with respect to the IR camera 160, to align the location of each welded joint WXx in the array 38 with its corresponding signature spot SXx in the thermogram 40 to be recorded and generated by the IR camera 160 and/or processor 165. Each signature spot SXx may be located to correspond, for example, with an area of the surface of the corresponding wire end pair 24 displayed to the IR camera 165 when the stator 10 is oriented in the fixture 32. As described previously, the temperature measurement area defined by the signature spot SXx may be of any appropriate size, corresponding to a sub-image of the thermogram 40 which may be, for example, 3×3 pixels or greater in size. The size and location of the signature spot SXx on the welded surface of the wire end pair 24 may be established to optimize the discrimination of an acceptable or sufficient weld from an unacceptable or insufficient weld.

The optimized size and location of the signature spot SXx may be determined, for example, empirically, be analyzing various sub-images of differently sized welds 26 taken from different locations on the welded surface of a series of wire end pairs 24 each having a weld 26 of a known size and/or configuration, such as the series of welds 26A through 26H shown in FIG. 4. In a non-limiting example, the signature spot SXx may be located to correspond, for example, with the approximate center point of the surface of the corresponding wire end pair 24 displayed to the IR camera 160 when the stator 10 is oriented in the fixture 32, e.g., the location indicated at 26A in FIG. 4. This center point of the wire end pair 24 may represent, for example, the ideal or optimized location for placement of the weld 26 to ensure the weld 26 penetrates the adjacent surfaces of the two wire ends 20 forming the wire end pair 24 during the welding process, to create a uniform and sufficiently sized electrically conductive path through the weld 26 and between the two wire ends 20. An undersized, off-center, misplaced, malformed, misshapened, included, or otherwise insufficient weld may not provide a sufficient conductive path between the two wire ends 20, which may cause a failure of the stator 10, or be detrimental to the performance of the stator 10, by creating an open circuit (also referred to as an open), hot spot or other defective condition in the stator circuit formed by the plurality of bar pins 14 and welded joints WX. By locating the signature spot SXx the midpoint of the wire end pair surface, the capability to detect variability in the welding process that may be detrimental to forming a sufficient weld 26 may be enhanced.

It would be understood that the rate of temperature increase of the signature spot SXx may be related to the size and integrity of the electrically conductive area of the weld 26 forming the welded joint WXx corresponding to the signature spot SXx. The size of the electrically conductive area of the weld 26 may be proportional to the size and cross-sectional area of the weld 26, which may also be referred to as the weld bead, such that as the size and/or cross-sectional area of the weld 26 increases, the size of the electrically conductive area available to conduct current from one to another of the wire ends 20 forming the welded joint WXx increases. The measured temperature and rate of temperature increase during the energizing cycle may be inversely proportional to the size of the conductive area, as shown in the example illustrated by FIGS. 3 and 4, such that a smaller weld 26, such as weld 26B, may exhibit a higher temperature and higher rate of temperature increase during the energizing cycle, as shown by profile 48B, than a larger weld 26, such as weld 26G corresponding to profile 48G.

The integrity of the weld 26 can affect the temperature and/or rate of temperature change of the weld during the energizing cycle. For example, discontinuities such as voids, non-conductive contaminants or inclusions in the weld, may be detrimental to the weld integrity, e.g., can decrease the weld integrity, effectively reducing the conductive area, increasing the resistance of the weld material, and/or decreasing the electrical conductivity of the weld 26. Therefore, the weld integrity exhibits an inversely proportional relationship to the temperature and rate of temperature increase during the energizing cycle, where a lower integrity weld 26 is shown to exhibit a higher temperature and higher rate of temperature increase during the energizing cycle, than a more uniform, higher integrity weld 26.

In a non-limiting example, each of the welds 26A . . . 26H shown in FIGS. 1B and 4 is identifiable to a corresponding welded joint WXx shown in FIG. 1B and a corresponding signature spot SXx shown in FIG. 2. Referring to FIGS. 1-4, the welded joint WA1, which is in an oriented position in fixture 32, is formed by a weld 26E, the size and pattern of which may be seen in detail in FIG. 4. The stator 10 may be energized and a series of thermograms 40 of the array 38 including the welded joint WA1 may be recorded over time and a signature spot SA1 shown in FIG. 2 and corresponding to the welded joint WA1 may be analyzed to generate the temperature-time profile 48E characteristic of the weld 26E. Other welded joints WXx having welds of known sizes, such as the welds 26A . . . 26H shown in the weld size reference chart 50 shown in FIG. 4, may be analyzed to develop a characteristic temperature-time profile for each weld size, as shown in the reference profile chart 46 of FIG. 3. These temperature-time profiles 48A . . . 48H may be used as reference profiles, individually or in combination, during the evaluation of a weld 26.

A signature spot SXx of a welded joint WXx may be evaluated by comparison to the reference profiles 48A . . . 48H, to determine the closest matching reference profile and to estimate the weld size of the weld 26 forming the welded joint WXx. The criteria for determining the closest matching reference profile may be defined, for example, by an algorithm provided to the processor 165 of FIG. 8. By determining the closest matching reference profile, the weld size of the weld 26 forming the welded joint WXx may be estimated. The estimated weld size may be compared to a minimum acceptable weld size for the stator 10, to qualify the weld 26 as sufficient, e.g., providing the minimum acceptable weld size for the stator application.

The reference profiles 48A . . . 48H of a series of known welds, such as welds 26A . . . 26H, or other experimental data, may be used to empirically determine a maximum temperature at a predetermined time tₜₑₛₜ for an acceptable weld. As described previously, the temperature and rate of temperature rise is relatively higher for a weld 26 having a smaller conductive area, e.g., a weld 26 of a smaller size and/or of decreased integrity. Therefore, an insufficient or unacceptable weld 26, e.g., one which is undersized, misplaced, misshapen, containing voids, contaminated, etc. resulting in a smaller conductive area, may be characterized by a higher temperature at any given time t during the energizing cycle, and may be characterized by a higher rate of temperature rise over the interval t=0 to tₜₑₛₜ, such that a maximum temperature may be determined, which when exceeded by an energized weld 26 prior to time tₜₑₛₜ, may qualify a weld 26 as unacceptable or insufficient for the application.

The reference profiles 48A . . . 48H of a series of known welds, in combination with temperature limits such as Tₘₐₓ, rate of temperature increase, or other factors correlated to acceptability of a weld, and/or other information, such as the magnitude of the activating current, the test time, IR camera settings, etc., may be analyzed to develop an algorithm which may be used to correlate data obtained from a thermographic image 40 of a weld array 38 to evaluate and/or qualify a weld 26 in the weld array 38. Multiple reference profiles 48 may be generated for each of a series of known welds 26 and information obtained from the multiple profiles may be used to model statistical variation in the algorithm. Variability in other parameters, including activation current, test time, positioning or fixture variability, etc., may be measured, inputted and modeled in the algorithm. The algorithm may be used to evaluate the welds in the array 38 to determine the acceptability of the weld, evaluate the weld size, etc. using input from the thermographic image 40, and other inputs as defined by the algorithm. The algorithm may be formulated to use multiple criteria to evaluate a weld. For example, the temperature or rate of temperature increase at two different times t may be used in determining weld acceptance or to estimate weld size and quality.

In a non-limiting example, referring to FIGS. 3 and 4, welds 26A, 26B and 26C, may be determined to be insufficient or unacceptable for the application, in the present example of a welded joint WXx of the stator 10, based on empirical data such as durability or functional test of welds of these sizes and/or configurations, destructive evaluation of welds of these sizes and/or configurations, etc. Welds 26D . . . 26H may be determined to be sufficient or acceptable for the application, with weld 26D determined to be the smallest size weld 26 which is sufficient or acceptable, based on empirical data such as durability or functional test of welds of these sizes and/or configurations, destructive evaluation of welds of these sizes and/or configurations, etc. As shown in the reference profile graph of FIG. 4, the temperature of the smallest size acceptable weld 26D, as determined from its temperature-time profile 48D, reaches a temperature indicated at 64 in FIG. 3, which may be established as Tₘₐₓ at time tₜₑₛₜ. Tₘₐₓ may be established as a predetermined temperature for weld 26 evaluation purposes, such that any weld 26 characterized by a signature spot SXx having a temperature exceeding Tₘₐₓ prior to time tₜₑₛₜ may be qualified as an unacceptable weld 26. Each of the insufficient welds 26A . . . 26C, as determined from their respective temperature-time profiles 48A . . . 48C, exceeds a temperature Tₘₐₓ prior to time tₜₑₛₜ. In a non-limiting example of a bar pin stator 10, a weld 26 characterized by a signature spot SXx exceeding a temperature Tₘₐₓ of 180 C may be qualified as insufficient or unacceptable.

Other methods of evaluating a weld 26 of a welded joint WXx using one or more temperature-time profiles are possible. For example, the graph shown in FIG. 5A, a portion of which is enlarged in FIG. 5B, may include a plurality of temperature-time profiles collectively referred to as profiles 48, derived from data captured for a plurality of signature spots SX from a time series of thermograms 40, where each of the plurality of temperature-time profiles 48 corresponds to a signature spot SXx and a welded joint WXx formed by a weld 26. In a non-limiting example, the plurality of temperature-time profiles 48, including the profiles 48x, 48y, 48z, may be statistically analyzed using commonly known techniques, to determine descriptive statistics for the plurality of profiles which may include, for example, the mean, median and standard deviation of the temperatures of the plurality of profiles at any time t. Criteria for evaluating each of the plurality of profiles may be developed based on the statistical characteristics, e.g., the descriptive statistics, for the plurality of profiles. In a non-limiting example, the plurality of profiles may be obtained from one or more control or master units, e.g., one or more arrays 38 fabricated with a plurality of welded joints WX under controlled conditions to produce a plurality of welds 26 representing a desired or acceptable distribution of weld sizes and characteristics. In another non-limiting example, the plurality of profiles may be obtained from a plurality of arrays 38 which may represent an acceptable level of variation of the welding process forming the plurality of welds 26 represented by the plurality of arrays 38.

By way of non-limiting example, any profile 48 including a temperature which is determined to be outside a predetermined limit or set of limits may be identified as corresponding to an unacceptable weld 26. The limits may be statistically determined, such as limits derived from ±3 sigma deviations from the mean temperature at any time t. Referring now to FIG. 5B, and applying the example criteria, it would be determined that the weld 26 corresponding to the profile 48z would be acceptable, as the profile 48z would be determined to be within the ±3 sigma limits, e.g., within the normal distribution of profiles 48 for the plurality of profiles 48 shown. Using the same criteria, the profile 48x may be determined to lie outside the ±3 sigma limits, e.g., beyond the normal distribution of profiles 48 for the plurality of profiles 48 shown, and the corresponding weld 26 may be determined to be unacceptable.

More than one criteria may be combined to evaluate a weld 26 represented by a temperature-time profile 48. In a non-limiting example, combining the criteria previously discussed, e.g., using an empirically derived limit of temperature Tₘₐₓ prior to tₜₑₛₜ, and statistically derived ±3 sigma limits, the criteria may be combined such that the evaluation of a profile 48 is dependent upon its rejection under both criteria. Under this example, the profile 48x would be found rejected under both criteria, having exceeded Tₘₐₓ at a time prior to tₜₑₛₜ, indicated at 62, and having been determined to lie outside the ±3 sigma limits, as discussed previously, and therefore the weld 26 corresponding to the profile 48x would be determined unacceptable. Continuing with the example, another profile 48y may be determined to be outside the ±3 sigma limits, but is found not to exceed Tₘₐₓ prior to a tₜₑₛₜ, but after tₜₑₛₜ, as indicated at 66, and therefore the corresponding weld 26 would be determined acceptable, having been rejected under one, but not both, criteria.

Other evaluation criteria may be established. Again referring to FIG. 5B, temperature-time profile quadrants I, II, III, IV may be established based on the intersection of Tₘₐₓ at time tₜₑₛₜ, indicated at point 64, and each profile 48 evaluated by quadrant. By way of non-limiting example, a weld 26 corresponding to any profile 48 traversing quadrant I, such as profile 48x, may be qualified as unacceptable. Continuing, a weld 26 corresponding to any profile 48 traversing quadrant II, such as profile 48y, may be qualified as conditional, e.g., and may be subjected to additional testing or retesting. In this example, a profile 48, such a profile 48z, which lies completely within the collective quadrants III and IV may be qualified as acceptable.

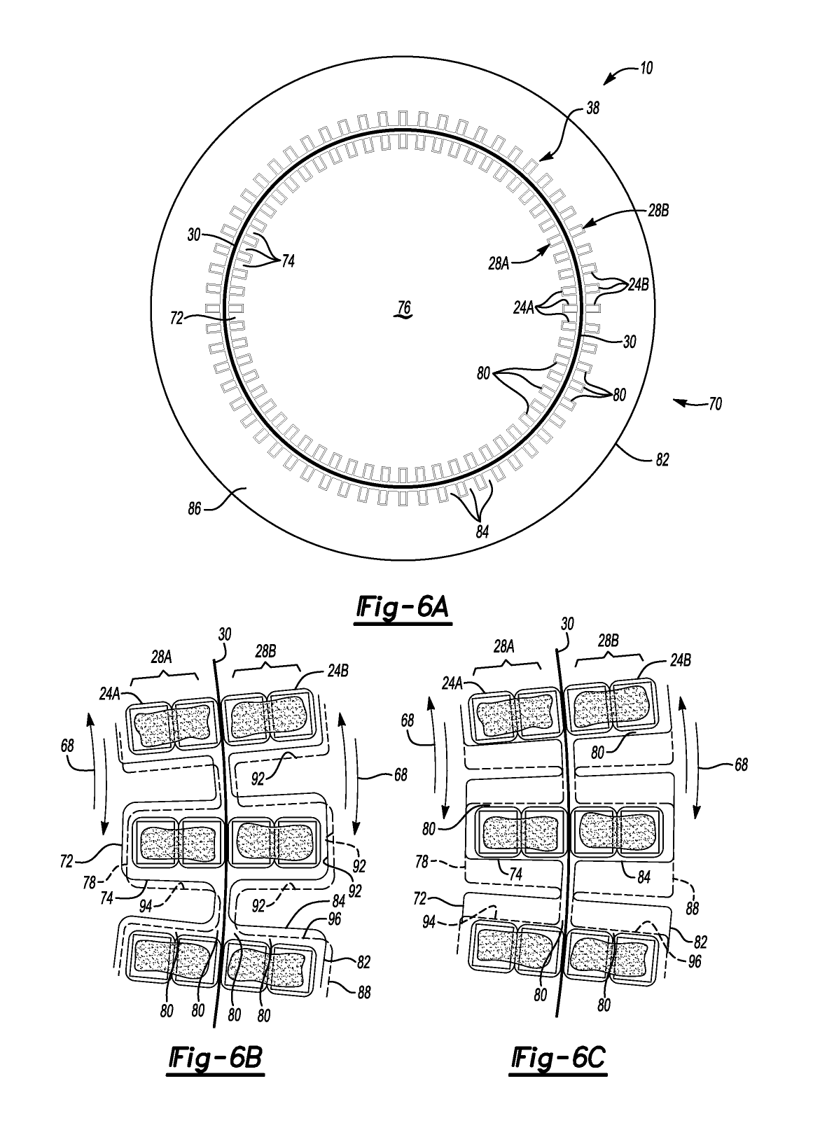

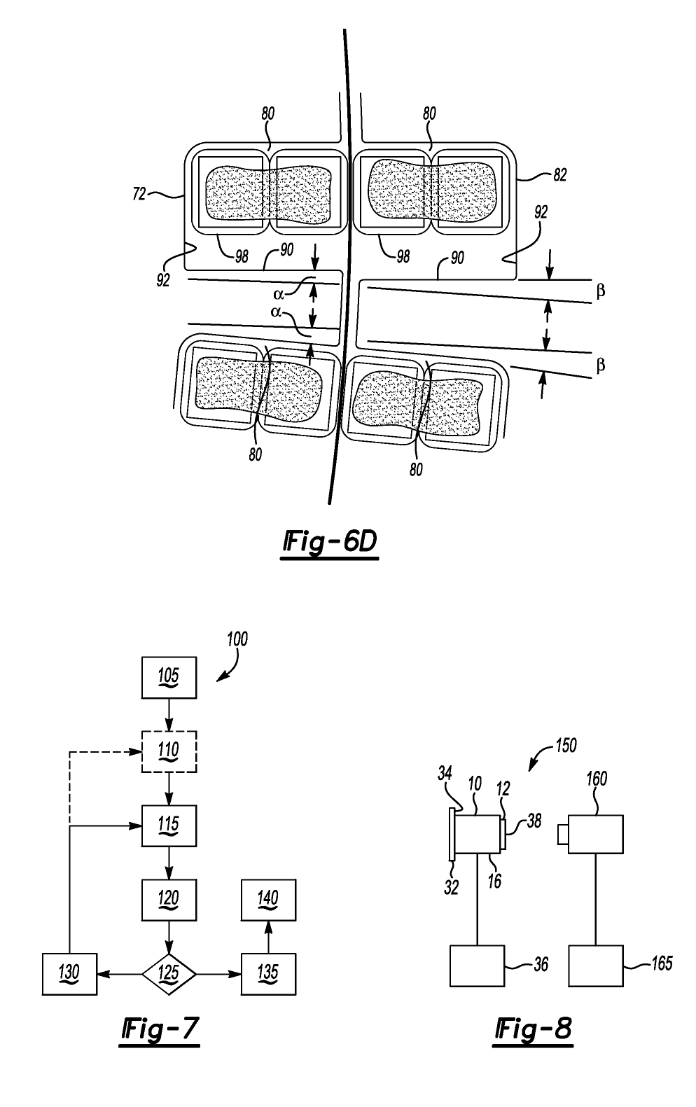

FIG. 6A shows, in a non-limiting example, a masking device 70 positioned relative to the array 38. The masking device 70 is configured to isolate the area or areas being evaluated, such that reflections and/or emissions from background sources of thermal radiation other than the areas being evaluated are masked and substantially reduced. In the present example, the area being evaluated may be the array 38, or specifically, may be the plurality of welded joints WX within the array 38 where the welded surface of each of the welded joints WX represents one of a plurality of areas being evaluated, or more specifically, the plurality of signature spots SX, where the surface area of each of the welds 26 corresponding to a signature spot SXx represents one of a plurality of areas being evaluated. By isolating the areas being evaluated from other background sources of reflection and/or emissions, the thermal energy recorded by the IR camera 160 of FIG. 8 may be substantially isolated to thermal energy from the areas being evaluated, such that the sensitivity of the thermogram 40 may be increased which may increase the accuracy of temperature readings derived from a thermogram 40 and used to generate temperature-time profiles 48 for the signature spots SX of the energized array 38.

Sources of emissions or reflections which may be masked may include emissions or reflections from background objects, areas and/or surfaces, where background objects, areas and/or surfaces include those objects, areas and/or surfaces which are other than the areas or objects being evaluated and are viewable by the IR camera 160 within the image captured by the thermogram 40. The emissions or reflections which are produced by background objects, areas and/or surfaces may be referred to herein as background emissions and background reflections, and the sources producing these may be referred to herein as background sources. A background source may be, but is not required to be, characterized by an emissivity which is substantially different than the area under evaluation, where emissivity is expressed as a unit less measure of the efficiency of the surface of an object to radiate IR radiation. For example, the emissivity of the backing plate 34 of the fixture 32 may be approximately 0.5, substantially different from the emissivity of the energized welds 26 under evaluation. Kirchoff s Law states that emissivity (E) plus reflectivity (R)=1.0, when transmission (T) equals 0.0. Applying Kirchoff s Law, the backing plate 34 in this example would have a reflectivity of 0.5 (50%) possibly offering a source of background thermal reflections into the radiometric IR camera 160.

The background sources of thermal energy (of background emissions and/or background reflections) for which masking may be desirable may include background sources which are adjacent to the surfaces or areas under evaluation. In the present example, the surface of the lamination pack 16 adjacent to the array 38 may be considered a background source. The surface of the lamination pack 16 may be characterized by a different emissivity than the array 38 or welds 26, and may also be a source of reflections. Another background source in the present example may include the surfaces of the bar pins 14 between the surfaces of the welded wire end pairs 24 (see FIG. 1B) which may be viewable by the IR camera 160 and captured by the thermogram 40. Other background sources which may be non-adjacent to the array 38 under evaluation may include, in the present example, the facing or back plate 34 of the fixture 32, other elements of the fixture 32, other elements of the stator 10 such as the slots 13, shown in the thermogram of FIG. 2, the surfaces of the lamination pack 16 separating the slots 13, and/or the circumferential gap separating the first and second layers 28A, 28B shown in FIGS. 1A, 1B, 6A-6D including a dividing element 30 inserted between the layers 28A, 28B.

Various configurations of the masking device 70 are possible. The masking device 70 may be defined by one or more features configured to conform with the areas under evaluation, such that the background sources are substantially masked by the masking device 70, and the areas under evaluation are substantially isolated from the background sources and reflections of thermal energy and/or emissions there from. The masking device 70 may be fabricated from any suitable material, which may preferably be characterized by a uniform emissivity and/or uniform reflectivity. In a non-limiting example, the masking device 70 may be made of paper, plastic or other polymeric materials, or a combination of these, such as phase paper. The material or materials selected to fabricate the masking device 70 are preferably of sufficient durability to permit reuse of the masking 70 or elements thereof such that the masking device 70 may be installed to the stator 10 prior to testing and removed after testing such that the removed masking device 70 remains in a condition suitable for reuse during testing of another stator 10. In a non-limiting example, at least a portion of the masking device 70, or elements thereof, may be coated or otherwise treated or modified to improve durability or reusability of the masking device, to increase heat resistance to heat from a welding operation forming the welds 26 or an energizing cycle of the array 38, and/or to modify the emissivity or reflectivity of the masking device to optimize thermal analysis conditions, etc.

The masking device 70 may be include one or more features used for orientation and/or installation of the masking device 70 to the object being evaluated, in the present example, the welds 26 of an array 38 of a stator 10, or for identification of the masking device with respect to the stator 10 or an element thereof. For example, the masking device 70 may include an orienting and/or identifying feature (not shown) to identify the welded joints WA1, WB2 in the array 38, to provide a datum from which the remaining welded joints WA2 . . . WAn and WB2 . . . WBn may be identified, or to identify another orienting feature of the array 38 or stator 10. The orienting and/or identifying feature of the masking device 70 may be configured to be distinguishable or identifiable in a thermogram 40.

In a first non-limiting example, a masking device 70 is shown in FIG. 6A masking a stator 10 to isolate the wire end pairs 24A, 24B of the array 38 from background sources. The masking device 70 may include a first masking element 72 and a second masking element 82. The masking device 70 may optionally include a dividing element 30, also referred to herein as a divider, which may be made of phase paper. As shown in FIG. 6A, the masking device 70 is configured to minimize a gap or spacing 80 between the elements of the masking device 70 and the wire end pairs 24A, 24B, which are under evaluation in the example shown, when the masking device 70 is in an installed position with respect to the stator 10 and array 38. By minimizing the gap 80 using the masking device 70, the wire end pairs 24A, 24B are substantially isolated from substantially all emissions and reflections from background thermal sources, to increase the accuracy of temperature measurements of signature spots SX corresponding to the welds 26 joining each of the wire end pairs 24A, 24B determined from a thermogram 40 of the masked stator 10.

The divider 30 may be configured as a generally annular member, which may be shaped as a ring (see FIGS. 1A and 1B) which is insertable in the circumferential space or gap between the first and second layers 28A, 28B consisting of wire end pairs 24A, 24B, respectively. In a non-limiting example, the divider 30 may be configured for use with the masking device 70, to mask reflections from the circumferential gap between the layers 28A, 28B. The divider 30 may be further configured for use for other purposes, for example, the divider 30 may provide phase-to-phase electrical insulation between the wire ends 20B and 20C, and/or between the welds WA and WB.

The first masking element 72, in a first non-limiting example shown in FIG. 6A, may be configured as a generally flat sheet defined by a generally circular shape which may include a plurality of extensions or tabs 74 extending radially outward from a generally circular body portion 76 to collectively define a perimeter 92 (see FIG. 6D) of the first masking element 72. The body portion 76 and the tabs 74 may be configured such that the perimeter 92 of the masking element 72 generally conforms with the innermost surface of the divider 30 (defined by the inner diameter of the divider 30) and the three sides of the wire end pairs 24A (including the sides 98 shown in FIG. 6D) which are non-adjacent to the divider 30, such that a gap or spacing 80 between each of the wire end pairs 24A and the masking elements 72, 30 is minimized.

The second masking element 82, in the non-limiting example shown in FIG. 6A, may be configured as a generally flat sheet including a body portion 86 defining a generally circular opening which may include a plurality of extensions or tabs 84 extending radially inward to collectively define a perimeter 92 (see FIG. 6D) of the second masking element 82. The body portion 86 and the tabs 84 may be configured such that the perimeter 92 of the masking element 82 generally conforms with the outermost surface of the divider 30 (defined by the outer diameter of the divider 30) and the three sides of the wire end pairs 24B (including the sides 98 shown in FIG. 6D) which are non-adjacent to the divider 30, such that a gap or spacing 80 between each of the wire end pairs 24B and the masking elements 82, 30 is minimized. The body portion 86 is shown in FIG. 6A as having a generally annular shape, although this configuration is not intended to be limiting. For example, the outer most perimeter of the second masking element 82 may be extended to increase the background area masked by the body portion 86. For example, the second masking element 82 may be configured as a generally rectangular sheet where the inner perimeter of the body portion 86 defines the generally circular opening, as described previously, and the width and length of the outermost perimeter of the body portion of the rectangular sheet is of sufficient size to mask the entirety of the background area viewed by the IR camera 160 of FIG. 8 to generate the thermogram 40.

In a second non-limiting example, the masking device 70 may be generally configured as described for the first example, including the first and second masking elements 72, 82 but without the optional divider 30. In this example, the radial length of the tabs 74, 84 may be increased such that the tabs 74, 84 overlay each other when the first and second masking elements 72, 82 are in an installed position, to mask at least a portion of the background masked by the divider 30 in the first example while reducing the number of masking elements from three to two.

In a third non-limiting example, and referring now to FIGS. 6B and 6C, the masking device 70 may be generally configured as described for the first example, further including a third masking element 78 and a fourth masking element 88. The first and third masking elements 72, 78 may be generally configured as described for the first masking element 72 in the first example, such that the first and third masking elements 72, 78 may be, but are not required to be, substantially identical. In this third example, the width of each tab 74, e.g., the width measured along a circumference passing through each tab 74, is less than the spacing between circumferentially adjacent wire end pairs 24A such that in an installed position, a gap 80 of sufficient width or clearance exists between a side 94 of each tab 74 and a side 98 of at least one of each two adjacent wire end pairs 24A when one of the first and third masking elements 72, 78 is in an installed position such that the background is perceivable through the gap 80.

A gap 80 which is perceivable, as used herein, has sufficient clearance such that the background area which is not masked by the masking element 72, 78 may be perceivable in camera view when stator 10 is positioned in the fixture 32. As such, it would be understood that a reflection and/or emission from the background area which is camera viewable through the perceivable gap 80 may also be recordable on a thermogram 40 generated from the camera viewable array 38 and masking elements 72, 78 positioned such that a perceivable gap 80 is viewable. The reduced width of the tabs 74 in this third example, as compared with the first or second example, improve the ease of insertion, removal, and/or placement of the tabs 74 between adjacent wire end pairs 28A, and may reduce distortion or installation damage to the tabs 74 to facilitate reuse of the masking elements 72, 78.

FIG. 6B shows the first and third masking elements 72, 78 in a first position, which may also be referred to as an unrotated position, where one of the first and third masking elements 72, 78 is in a layered relationship with the other of the first and third masking elements 72, 78, such that gap 80 is perceivable and exists between at least one side of a tab 74 of at least one of the first and third masking elements 72, 78 and at least one side 98 of one of the adjacent wire end pairs 24A. FIG. 6C shows the first and third masking elements 72, 78 in a second position, which may also be referred to as a rotated position, where one of the first and third masking elements 72, 78 is in a layered relationship with the other of the first and third masking elements 72, 78, and has been rotated circumferentially, as indicated by the arrows 68, such that a side 94 of a tab 74 of one of the first and third masking elements 72, 78 is proximate to or in proximate contact with a side 98 (see FIG. 6D) of a wire end pair 24A, and a side 94 of a tab 74 of the other of the first and third masking element 72, 78 is proximate to or in proximate contact with a side 98 of the adjacent wire end pair 24A, and such that the gap 80 which was perceivable in the first position has been substantially closed or reduced. In the second, or rotated position shown in FIG. 6B, the rotated tabs 74 of the first and third masking elements 72, 78 substantially block the background area between adjacent wire end pairs 24A.

The second and fourth masking elements 82, 88 may be generally configured as described for the second masking element 82 in the first example, such that the second and fourth masking elements 82, 88 may be, but are not required to be, substantially identical. In this third example, the width of each tab 84, e.g., the width measured along a circumference passing through each tab 84, is less than the spacing between circumferentially adjacent wire end pairs 24B such that in an installed position, another gap 80 of sufficient width or clearance exists between a side 94 of each tab 84 and a side 98 of at least one of each two adjacent wire end pairs 24B when one of the second and fourth masking elements 82, 88 is in an installed position such that the background is perceivable through the gap 80.

Another gap 80 of sufficient clearance such that the background area which is not masked by the masking element 82, 88 may be perceivable in camera view when stator 10 is positioned in the fixture 32. As such, it would be understood that a reflection and/or emission from the background area which is camera viewable through the perceivable gap 80 may also be recordable on a thermogram 40 generated from the camera viewable array 38. The reduced width of the tabs 84 in this third example, as compared with the first or second example, improve the ease of insertion, removal, and/or placement of the tabs 84 between adjacent wire end pairs 28B, and may reduce distortion or installation damage to the tabs 84 to facilitate reuse of the masking elements 82, 88.

FIG. 6B shows the second and fourth masking elements 82, 88 in a first position, which may also be referred to as an unrotated position, where one of the first second and fourth masking elements 82, 88 is in a layered relationship with the other of the second and fourth masking elements 82, 88, such that another gap 80 exists between at least one side of a tab 84 of at least one of the second and fourth masking elements 82, 88 and at least one side 98 of one of the adjacent wire end pairs 24B. FIG. 6C shows the second and fourth masking elements 82, 88 in a second position, which may also be referred to as a rotated position, where one of the second and fourth masking elements 82, 88 is in a layered relationship with the other of the second and fourth masking elements 82, 88, and has been rotated circumferentially, as indicated by the arrows 68, such that a side 94 of a tab 84 of one of the second and fourth masking elements 82, 88 is proximate to or in proximate contact with a side 98 of a wire end pair 24B, and a side 94 of a tab 84 of the other of the second and fourth masking elements 82, 88 is proximate to or in proximate contact with a side 98 of the adjacent wire end pair 24B, and such that the gap 80 which was perceivable in the first position has been substantially closed or reduced. In the second, or rotated position shown in FIG. 6B, the rotated tabs 84 of the second and fourth masking elements 82, 88 substantially block the background area between adjacent wire end pairs 24B.

In a fourth non-limiting example shown in FIG. 6D, the sides 94 of the tabs 74 of the first and third masking elements 72, 78 may be tapered outward with respect to a radial line bisecting the tab 74, as indicated at 90, where the taper is defined by an angle α, such that when the first and third masking elements 72, 78 are in a second or rotated position, a tapered edge 90 of a tab 74 of each of the first and third masking elements 72, 78 conforms to or is in conforming contact with a side 98 of adjacent wire end pairs 24A, to substantially eliminate the gap 80 therebetween. The angle α may be established in relationship to the radial distribution of the plurality of wire end pairs 24A, to produce the conforming relationship between the tapered edge 90 and the wire end pair side 98.

Similarly, as shown in FIG. 6D, the sides 94 of the tabs 84 of the second and fourth masking elements 82, 88 may be tapered inward with respect to a radial line bisecting the tab 84, as indicated at 90, where the taper is defined by an angle β, such that when the second and fourth masking elements 82, 88 are in a second or rotated position, a tapered edge 90 of a tab 84 of each of the second and fourth masking elements 82, 88 conforms to or is in conforming contact with a side 98 of adjacent wire end pairs 24B, to substantially eliminate the gap 80 therebetween. The angle β may be established in relationship to the radial distribution of the plurality of wire end pairs 24B, to produce the conforming relationship between the tapered edge 90 and the wire end pair side 98.

The array 38 under evaluation may be modified, for example, to optimize or improve the sensitivity, accuracy, repeatability and/or reliability of the weld evaluation. The modifications may be configured such that the welds 26 and welded joints WX are not functionally affected thereby, e.g., the operation of the stator 10 is substantially unaffected by the modifications. For example, the surface of the area under evaluation may be modified, which in the present example may include a weld 26 or the welded surface of a welded joint WX, to modify the emissivity and/or reflectivity of the area under evaluation. In a non-limiting example, the surface may be modified by application of a coating (not shown), which may be a pigmented coating such as a paint, to modify the emissivity of the surface, and/or to increase the emissivity and/or the uniformity of emissivity of the areas under evaluation in a thermogram 40. In another non-limiting example, the coating may be one of an epoxy coating, a varnish, an insulating coating, or a combination of these, which may be modified to include an additive such as a pigment to control and/or standardize the emissivity of the plurality of welds 26, including substantially standardizing the emissivity of the areas under evaluation when energized or activated. The coating may be thermally conductive and highly sensitive to the weld temperature, and have a relatively high emissivity such that the IR radiation emitted from the coating may be strongly correlated to the weld temperature and accordingly, to the weld size estimated based on the measured weld temperature. The coating may be electrically insulating, such that the coating may electrically insulate each of the plurality of welded joints WX from another of the plurality of welded joints WX, and from surrounding elements, which may include contaminants or other substances which may be in contact with the plurality of welded joints during fabrication or operation of the stator 10.

The coating may be characterized by a combination of properties, such that the coating may be electrically insulating and may also be configured to conduct thermal energy from the array of welded joints and to radiate the thermal energy with a relatively high emissivity. The coating may be applied in as a consistent, e.g., continuous, layer on the welded joints, to electrically insulate each of the welded joints. The coating may be sufficiently thick such that the coating is not transparent to infrared radiation. By way of example, a minimum coating thickness of 0.38 mm may be preferred such that the coating is not transparent to infrared radiation and conducts instead to exhibit a relatively high emissivity. As used herein, a coating characterized by a relatively high emissivity may exhibit an emissivity which is higher than the emissivity of an uncoated weld, may exhibit an emissivity which is sufficiently high such that the IR radiation emitted from the coating may be strongly correlated to the temperature of the coated weld, and/or may exhibit an emissivity which is sufficiently high to be distinguishable from the emittance and reflectance of the background sources and/or masking elements. By way of non-limiting example, given an uncoated weld with an emissivity of 0.2-0.7, and background sources including masking elements having reduced emittance and reflectance, a coating exhibiting an emissivity of greater than 0.7 may be considered a coating characterized by a relatively high emissivity. In a preferred embodiment, the coating has an emissivity of greater than 0.9, and in a most preferred embodiment, the coating has an emissivity of greater than 0.95.

FIG. 7 shows a flowchart 100 illustrating an example method which may be used for the non-destructive evaluation of a weld array 38 (see FIGS. 1A and 1B) using, in a non-limiting example, the system 150 to evaluate welds 26 of a stator 10, illustrated in FIG. 8. Additional testing may precede the method shown in the flowchart 100 to initially qualify the stator prior to thermographic evaluation. Such testing may include but is not limited to high potential and current surge tests. The flowchart 100, the system 150, and the stator 10 are not intended to be limiting and it would be understood that the method and system as described herein may be used to non-destructively evaluate an array of welds defined by an object which is other than a stator. Beginning at step 105, and also referring to FIG. 8, an object including an array 38 defined by a plurality of welds 26, and including at least one weld 26 to be evaluated, is oriented with respect to a thermographic camera. In the present example the object including an array 38 may be a stator 10 shown in FIG. 8, which as described previously would include at least one weld 26 forming a welded joint WX to be evaluated, and the camera may be an IR camera 160.

At step 110, which may be an optional step, the array 38 may be modified to establish a set of conditions for generating a thermogram 40 (see FIG. 2), where the modifications may include, by way of non-limiting example, one or more of installing a masking device 70 which may include a divider 30, modifying the area to be evaluated by coating or other methods to modify its emissivity and/or reflectivity, identifying, which may include marking, the location and/or orientation of one or more welds 26 to be evaluated. At step 115, the array 38 is energized or activated, for example, by an activating or current source 36, and at least one thermogram 40 is generated which may be analyzed to determine a temperature and/or temperature-time profile 48 for at least one signature spot SX, as described previously herein. At step 120, the thermogram or thermograms 40 and/or data derived therefrom are analyzed, in a non-limiting example, using a processor 165, to evaluate the at least one weld 26. At step 125, the evaluated weld 26 corresponding to the at least one signature spot SX is qualified as sufficient (acceptable) or insufficient (unacceptable), using the analysis results and/or data from step 120.

If the at least one weld 26 is qualified as sufficient or acceptable, the object including the array 38, in the present example, the stator 10, may proceed to one or more steps 135, 140, for example, for completion of additional processing. In a non-limiting example, the stator 10 may be assembled into a motor assembly (not shown) at step 135, and the motor assembly including the stator 10 may be tested at step 140, for example, by a functional tester or other form of end-of-line testing or evaluation method.

If the at least one weld 26 is qualified as insufficient or unacceptable, the object including the array 38, in the present example, the stator 10 may proceed to step 130 for rework or repair of the insufficient weld 26, or other suitable containment of the stator 10. Following rework or repair of the insufficient weld 26, the stator 10 may be retested as previously described for step 115, which may optionally include modifying the repaired array 38 for retesting as described previously for step 110.

It would be understood that the flowchart 100 is not intended to be limiting and that the order and/or combination of steps may be modified. For example, step 110 may be completed prior to step 105, and steps 120 and 125 may be combined. At least a portion of the method and system described herein may be automated, where by automating at least a portion of the method and system efficiencies in cost and throughput and/or increased repeatability and reliability of the test methods used may be realized. By way of non-limiting example, at least one of analyzing a thermogram 40, evaluating a temperature-time profile 48 produced therefrom, and qualifying a weld 26 may be automated.

Other steps of the test cycle may be automated, which may include, for example, automating handling of the stator 10 with respect to the fixture 32, where handling may include one or more of loading, locating, orienting, and/or unloading the stator 10 and/or connecting and/or disconnecting the array 38 to a current source 36, applying a coating to the weld array 38, installing and/or positioning a masking device 70 and/or divider 30 to the weld array 38, marking or otherwise identifying one or more welds 26 for correlation to test results, and/or to identify an insufficient weld 26 requiring rework or repair. In another non-limiting example, the system 150 may include a welding device configured to repair or rework an insufficient weld, where the repair and/or rework process may be completed automatically, and/or where the repair or rework may be completed while the stator 10 remains oriented in the test fixture, such that the repaired weld may be reevaluated and/or requalified without additional handling or delay in processing.

While the best modes for carrying out the invention have been described in detail, those familiar with the art to which this invention relates will recognize various alternative designs and embodiments for practicing the invention within the scope of the appended claims.

1. A method for non-destructive evaluation of an array of welded joints, the array of welded joints including a plurality of welds, the method comprising:
activating the plurality of welds using an electrical current provided to the array of welded joints to provide an activated array;
recording a plurality of thermal images of the activated array over time;
analyzing the plurality of thermal images to develop a temperature-time profile of at least one weld of the plurality of welds; and
evaluating the temperature-time profile to qualify the at least one weld.

2. The method of claim 1, wherein evaluating the temperature-time profile includes estimating the size of the at least one weld.

3. The method of claim 1, wherein evaluating the temperature-time profile includes comparing the temperature-time profile of the at least one weld to at least one reference temperature-time profile.

4. The method of claim 1, wherein evaluating the temperature-time profile includes determining if a measured temperature of the at least one weld has exceeded a predetermined temperature.

5. The method of claim 1, wherein activating the plurality of welds further includes:
providing the electrical current to the array of welded joints for a test time interval;
wherein at least one of the electrical current and the test time interval are limited to prevent deterioration of the array of welded joints.

6. The method of claim 1, further comprising:
masking the array of welded joints such that at least one of reflections and emissions from thermal sources other than the plurality of welds is substantially reduced.

7. The method of claim 1, further comprising:
coating the plurality of welds to substantially standardize emissivity of each of the plurality of welds when activated.

8. The method of claim 1, further comprising:
coating the array of welded joints with a coating that is electrically insulating, wherein the coating is configured to conduct thermal energy from the array of welded joints and to radiate the thermal energy with relatively high emissivity.

9. The method of claim 1, wherein at least one of activating the plurality of welds, recording a plurality of thermal images, analyzing the plurality of thermal images, and evaluating the temperature-time profile to qualify the at least one weld is automated.

10. The method of claim 1, wherein the array of welded joints is defined by the welded end portion of a bar wound stator.

11. A system for the non-destructive evaluation of a plurality of welds, the system comprising:
an electrical current source that is electrically connectable to the plurality of welds to selectively activate the plurality of welds;
an infrared camera configured to capture at least one thermographic image of the activated plurality of welds; and
a processor configured to analyze said at least one thermographic image to qualify at least one weld of the plurality of welds.

12. The system of claim 11, wherein:
the plurality of welds is defined by the wire end portion of a bar wound stator.

13. The system of claim 11, wherein the processor is further configured to estimate the size of the at least one weld.

14. The system of claim 11, wherein the processor is further configured to determine if the temperature of the at least one weld has exceeded a predetermined temperature at a predetermined time.

15. The system of claim 11, wherein:
the infrared camera is configured to capture a plurality of thermographic images of the activated plurality of welds over time;
the processor is configured to develop a temperature-time profile of said at least one weld of the plurality of welds using the plurality of thermographic images; and
the processor is configured to qualify the at least one weld by comparing the temperature-time profile of the at least one weld to at least one reference temperature-time profile.

16. The system of claim 11, further comprising:
a masking device configured to isolate the plurality of welds such that at least one of reflections and emissions from thermal sources other than the plurality of welds is substantially reduced.

17. The system of claim 16, wherein the masking device includes a plurality of masking elements which may be selectively arranged relative to each other.

18. The system of claim 12, further including:
an orienting mechanism to orient the plurality of welds with respect to the infrared camera, such that the location of said at least one weld with respect to the plurality of welds is identifiable.

19. A method for non-destructive evaluation of an array of welded joints of a stator, the array of welded joints including a plurality of welds, the method comprising:
orienting the stator with respect to an infrared camera, such that the location of each weld of the plurality of welds is identifiable in a thermal image produced by the infrared camera;
energizing the array of welded joints using an electrical current provided to the stator;
recording a plurality of thermal images of the energized array over time;
analyzing the plurality of thermal images to develop a temperature-time profile of at least one weld of the plurality of welds; and
evaluating the temperature-time profile of said at least one weld to qualify said at least one weld, including at least one of:
estimating the size of said at least one weld; and
determining if the temperature of said at least one weld has exceeded a predetermined temperature.

20. The method of claim 19, further including at least one of coating the plurality of welds to substantially standardize the emissivity of each of the plurality of welds when energized, and masking the array of welded joints to substantially reduce at least one of reflections and emissions from thermal sources other than the plurality of welds.
